(19) United States
(12) Patent Application Publication
(10) Pub. No.: US 2012/0197805 A1
(43) Pub. Date: Aug. 2, 2012

(54) METHOD AND APPARATUS FOR CAPTURING FINANCIAL DATA USING A CAMERA-EQUIPPED COMPUTING DEVICE

(75) Inventor: Christopher C. Chung, Fremont, CA (US)

(73) Assignee: INTUIT INC., Mountain View, CA (US)

(21) Appl. No.: 13/017,810

(22) Filed: Jan. 31, 2011

(51) Int. Cl. G06Q 40/00; H04L 9/30; G06F 17/00

(52) U.S. Cl. 705/64; 235/375

(57) ABSTRACT

The disclosed embodiments provide a system that captures financial data using a camera. During operation, the system uses the camera to scan a barcode that is associated with a financial document. The system decodes the barcode to generate a financial data set that is then input into a financial application. Allowing data to be input by capturing and decoding a scanned barcode reduces errors and generally improves the user data entry experience.

### BACKGROUND

1. Field of the Invention

This disclosure generally relates to techniques for capturing financial data using a camera-equipped computing device. More specifically, this disclosure relates to techniques for transferring financial data encoded in a barcode to a financial application.

2. Related Art

Easy access to computing devices and plentiful network bandwidth have made it very easy to share information and applications. For instance, users can easily download and execute a range of applications on portable computing devices such as tablets and smartphones. Factors such as larger screen sizes, increased computational capabilities, and inherent portability and convenience have made such devices the favorite computing platform of many users.

However, compact mobile devices also often have a number of limitations. Portability often comes at the expense of dedicated input mechanisms (e.g., replacing a full-size keyboard with a small virtual touch-screen keyboard), which can make data entry difficult. For example, manually inputting financial data into a smartphone can be a slow, frustrating, and error-prone process. Hence, what is needed are techniques for inputting data into a portable device without the above-described problems.

### SUMMARY

The disclosed embodiments provide a system that captures financial data using a camera. During operation, the system uses the camera to scan a barcode that is associated with a financial document. The system decodes the barcode to generate a financial data set that is then input into a financial application. Allowing data to be input by capturing and decoding a scanned barcode reduces errors and generally improves the user data entry experience.

In some embodiments, the financial document is a tax document, and the decoded data is used to populate a tax return.

In some embodiments, the data encoded in the barcode serves as a unique identifier that can be used to retrieve financial data from a remote server. For instance, the system may use identifying information encoded in the barcode to connect to, log in to, and/or retrieve data from a remote server that stores financial data. In some embodiments, retrieving such data may also require the user of the accessing computing device to provide additional authentication information to the remote server.

In some embodiments, the financial data may be input into a financial application that is hosted on a remote server. In some embodiments, the financial data encoded in the barcode has been encrypted using a public key associated with the remote server, and the remote server decrypts the financial data that it receives using a private key that is associated with the public key.

In some embodiments, the financial data encoded in the barcode has been signed by its creator to ensure data integrity and authenticity.

In some embodiments, the barcode is a multi-dimensional matrix barcode.

In some embodiments, the financial data is compressed prior to being encoded into the barcode.

### BRIEF DESCRIPTION OF THE FIGURES

FIG. 1A illustrates an exemplary barcode that encodes financial data in accordance with an embodiment.

FIG. 1B illustrates the financial data decoded from the exemplary barcode of FIG. 1A in accordance with an embodiment.

FIG. 2 illustrates an exemplary system in which a camera-equipped computing device captures and decodes a barcode in accordance with an embodiment.

FIG. 3 presents a flow chart that illustrates the process of capturing financial data using a camera-equipped computing device in accordance with an embodiment.

FIG. 4 illustrates a computing environment in accordance with an embodiment.

FIG. 5 illustrates a computing device in accordance with an embodiment.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or non-transitory medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, a full-custom implementation as part of an integrated circuit (or another type of hardware implementation on an integrated circuit), field-programmable gate arrays (FPGAs), a dedicated or shared processor that executes a particular software module or a piece of code at a particular time, and/or other programmable-logic devices now known or later developed. When the hardware modules are activated, the hardware modules perform the methods and processes included within the hardware modules.

### Capturing Financial Data Using a Camera-Equipped Computing Device

Ongoing improvements in the capabilities and convenience of network-enabled mobile computing devices have led to a wide range of mobile applications. For instance, smartphones can be used for navigation, web-browsing, email access, and banking purposes. However, such devices still have some significant limitations, especially for data entry. For example, mobile computing devices often have very small or virtual keyboards, which can make manually inputting large amounts of data slow, frustrating, and error-prone. Hence, data entry can be a problem for personal and/or business finance applications (such as tax preparation) that involve substantial data input but might otherwise be desirable and convenient on a mobile device.

Embodiments of the present invention provide techniques that improve data entry of financial data for camera-equipped computing devices. Financial data is encoded into a machine-recognizable format (e.g., a two-dimensional “Quick Response (QR) code”) that can be easily scanned and decoded using a mobile phone camera. Such machine-recognizable formats serve to facilitate error-free data entry, and can be integrated into a range of financial and/or other forms.

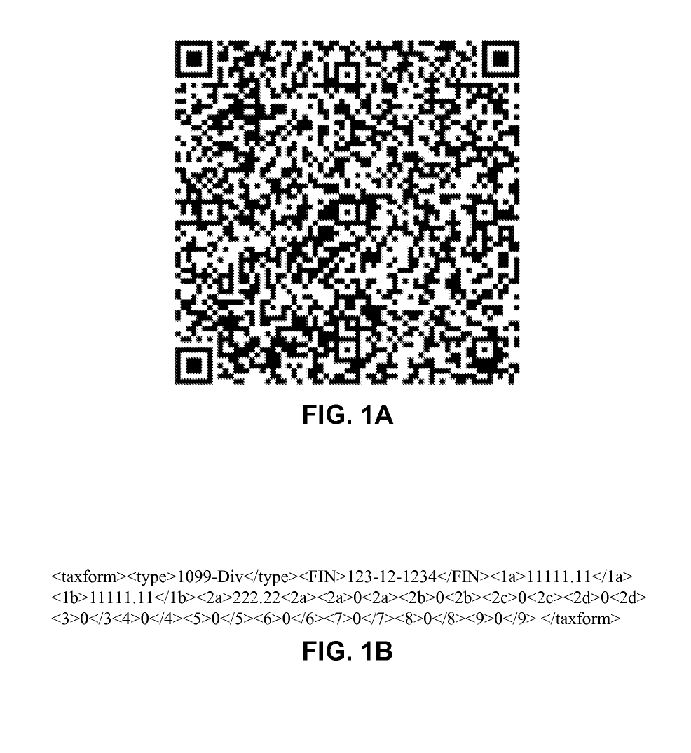

FIGS. 1A-1B illustrate the encoding of financial data in a QR code. More specifically, the QR code illustrated in FIG. 1A encodes an XML string containing information from a 1099-DIV tax form. The decoded XML string is illustrated in FIG. 1B. Note that the described techniques are not limited to barcodes or QR codes (which can encode on the order of 2000-7000 characters), but can use a range of single- and/or multi-dimensional machine-recognizable encoding formats with a range of data densities. For instance, a data provider may choose an encoding based on the amount of data that needs to be encoded and on the imaging and decoding capabilities of the intended target devices. Note that the term “barcode” is used generally in the following disclosure, and may refer to any machine-recognizable format. Note also that in some embodiments the data encoded may also be compressed to allow additional data to be stored in the barcode.

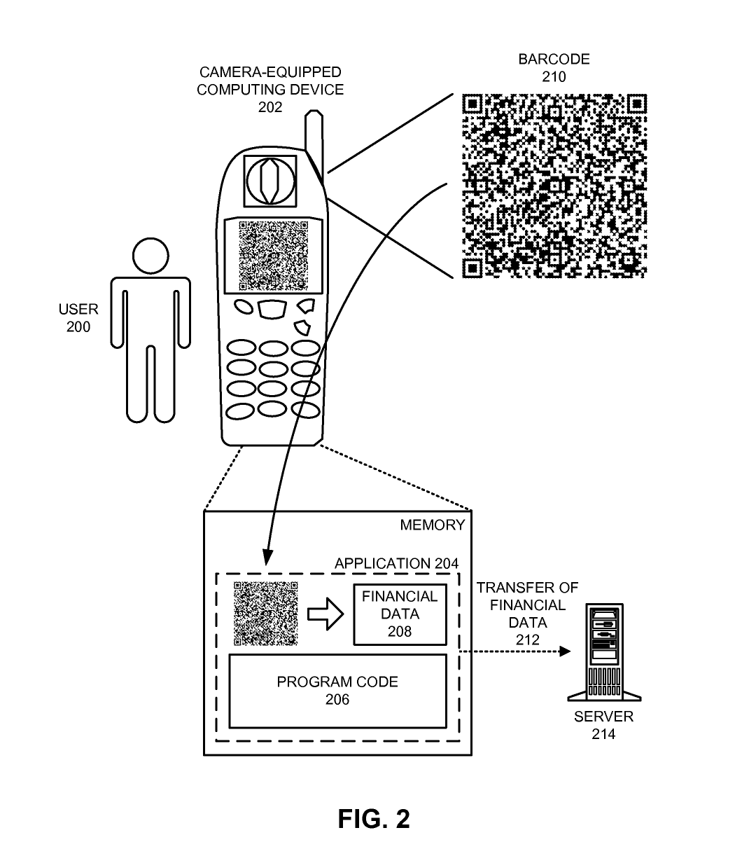

FIG. 2 illustrates an exemplary system in which a camera-equipped computing device 202 scans and decodes a barcode 210 printed on a financial document (not shown). For instance, upon receiving a W-2 tax form or payroll data containing barcode 210, user 200 may launch an application 204 on camera-equipped computing device 202 that scans barcode 210 into memory. The application's program code 206 includes recognition software that then decodes barcode 210 to generate the encoded financial data 208, which can subsequently be used by application 204 or input into another financial application. Application 204 may also optionally transfer 212 financial data 208 to one or more servers 214. Note that the described techniques benefit, but are not limited to, mobile devices. For example, locally installed or browser-based applications that include the needed barcode-recognition capabilities and execute upon a desktop computer with an attached “webcam” could also generate financial data 208. Note also that a financial document may be presented using a range of media types and/or formats. For instance, while the above example refers to a printed format, the barcode may also be presented to users directly using a display screen. For example, a user may log onto a payroll website that displays financial documents using such barcodes, and then use a mobile device to read the barcodes directly from the computer screen.

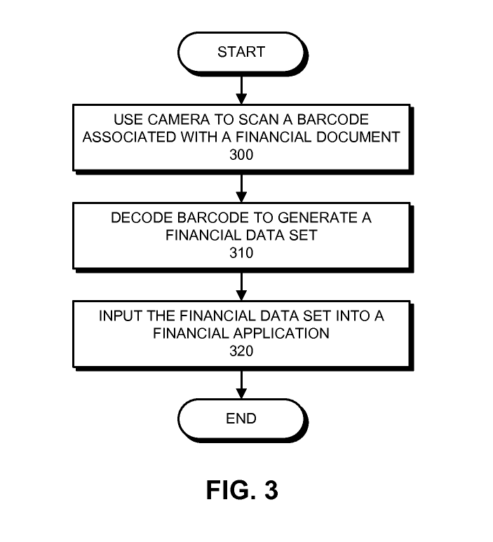

FIG. 3 presents a flow chart that illustrates the process of capturing financial data using a camera-equipped computing device. During operation, the system uses the camera to scan a barcode that is associated with a financial document (operation 300). The system decodes the scanned barcode to generate a financial data set (operation 310) that is then input into a financial application (operation 320). Allowing data to be input by capturing and decoding a scanned barcode reduces errors and generally improves the user data entry experience.

In some embodiments, the described techniques can be used to populate a tax return. For instance, organizations providing tax preparation documents (e.g., a W-2 form, 1099-INT form, 1099-DIV form, etc.) may append a QR code containing all of the included information at the end of each form. A user seeking to prepare their tax return on a mobile phone can install an application (or open a browser-based application) that can perform the needed scan and decode operations, and then proceed to successively scan the QR codes from the supplied documents until all of the data has been entered. Note that such scenarios may follow a range of possible configurations. For example:
Accessing such an application may involve identifying the type of device being used in order to download program code that includes suitable application and/or barcode recognition. For instance, this may involve logging into an online account that is associated with a given user and/or device, or specifying the hardware, operating system, and/or browser being used.
The executed application may perform a range of functionality. For instance, in some simpler implementations such an application may not store sensitive financial data on the computing device (e.g., in case the device is stolen or lost), but may instead simply forward the decoded data on to a more secure website or server. In other implementations, the executed application may include additional program code that stores, interprets and/or otherwise makes use of the decoded data.

In some embodiments, a barcode directly encodes financial data. However, depending on factors such as the sensitivity of the data and the vulnerability of the computing device, storing such information in an unprotected raw form may be undesirable. Hence, alternative embodiments may include encoding structures and/or options that improve security, authenticity, and accessibility. For instance, in some embodiments, the barcode may instead encode a unique identifier that can be used to access financial information located on a remote server. For example, the barcode may contain redirection information that indicates the location of financial data and a unique identifier that is needed to access such financial information. A user may also need to provide additional authentication information or other credentials to download (or forward) financial data stored on this remote server.

In some embodiments, the financial data encoded in a barcode can be encrypted in a manner that allows only certain applications and/or parties to interpret the decoded data. For instance, financial data being encoded into a barcode may first be encrypted using a public key that is associated with a tax preparation application and/or vendor. The device that scans and decodes the barcode may not have access to the private key that is needed to decrypt the financial data. Instead, the device may be configured to forward the encrypted data on to an online account associated with a financial application and/or a vendor that does have access to this private key. Such an arrangement may reduce the danger of sensitive data being accessed on the user's computing device.

In some embodiments, the data encoded in a barcode may also be signed by individual distributors to ensure integrity and to provide a clear, traceable return path. For instance, the provider (e.g., the entity distributing the financial information and creating the barcode) may digitally sign the data being encoded in the barcode using its private key (e.g., by including an encrypted hash digest of the data being encoded in the barcode). Any computing device decoding the data encoded in the barcode can then use the provider's public key to confirm (or prove) both the source of the data and the integrity of the encoded data. Note that, even if encryption and digital signature techniques are not used, data encoded in barcodes may still make use of other error-checking and/or error-correction techniques to reduce errors and detect (or recover from) damaged barcodes.

In some embodiments, the described techniques facilitate gathering and categorizing information, and can be used in any scenario where a user would like to load data onto a camera-equipped computing device. Such techniques can be especially useful for inputting standardized form data (e.g., tax and payroll forms, invoices, and procurement information) into computing devices with limited data entry capabilities. For instance, some specific applications might include:
Data entry of payroll and/or tax data information for a mobile tax estimation and planning application;
Data entry of payroll and/or tax information for a mobile tax deduction finder application; and
Data entry for a financial application that tracks receipts and categorizes spending (e.g., a retailer could display barcodes on a receipt or a point-of-sale display, thereby allowing customers to easily enter sales data into a financial application on their mobile phone).
   In some embodiments, application vendors or information distributors may establish standardized data models for encoded data, thereby facilitating the development of applications that can decode and use the data from barcodes.

In some embodiments, a user may access a barcode image via a different mechanism than scanning (e.g., receiving an image file via email, or by downloading such a barcode image from a financial website). In such embodiments, the user may decode the barcode image on the receiving device or may instead transfer the raw (undecoded) barcode to a financial application or website which then decodes the barcode and uses the contained financial information.

In summary, embodiments of the present invention involve techniques for improving data entry by capturing financial data using a camera-equipped computing device. Such techniques can overcome data entry difficulties for devices with limited data entry mechanisms, and hence enable a wide range of additional applications that might otherwise be infeasible for mobile devices.

### Computing Environment

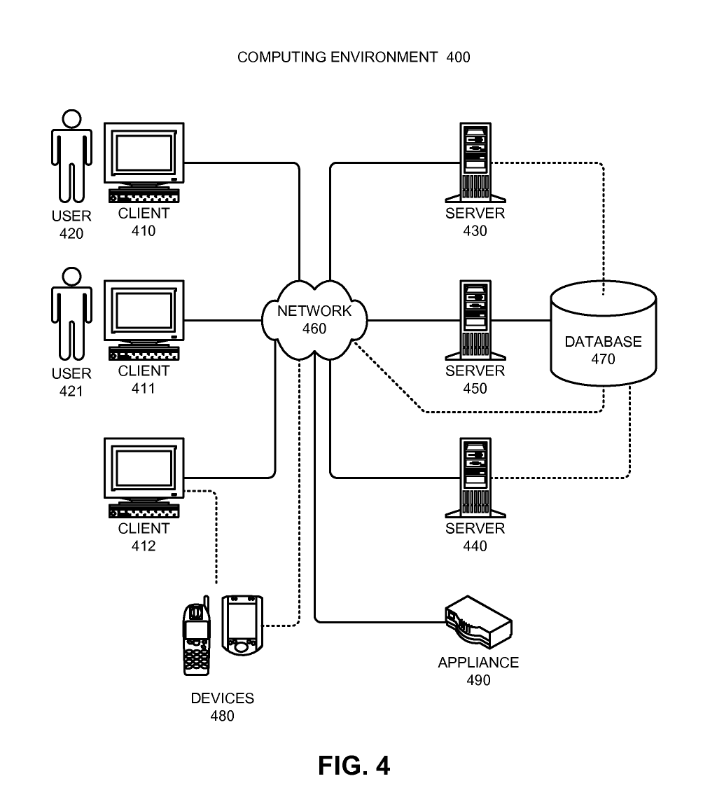

In some embodiments of the present invention, techniques for capturing financial data using a camera-equipped computing device can be incorporated into a wide range of computing devices in a computing environment. For example, FIG. 4 illustrates a computing environment 400 in accordance with an embodiment of the present invention. Computing environment 400 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 4, computing environment 400 includes clients 410-412, users 420 and 421, servers 430-450, network 460, database 470, devices 480, and appliance 490.

Clients 410-412 can include any node on a network that includes computational capability and includes a mechanism for communicating across the network. Additionally, clients 410-412 may comprise a tier in an n-tier application architecture, wherein clients 410-412 perform as servers (servicing requests from lower tiers or users), and wherein clients 410-412 perform as clients (forwarding the requests to a higher tier).

Similarly, servers 430-450 can generally include any node on a network including a mechanism for servicing requests from a client for computational and/or data storage resources. Servers 430-450 can participate in an advanced computing cluster, or can act as stand-alone servers. For instance, computing environment 400 can include a large number of compute nodes that are organized into a computing cluster and/or server farm. In one embodiment of the present invention, server 440 is an online “hot spare” of server 450.

Users 420 and 421 can include: an individual; a group of individuals; an organization; a group of organizations; a computing system; a group of computing systems; or any other entity that can interact with computing environment 400.

Network 460 can include any type of wired or wireless communication channel capable of coupling together computing nodes. This includes, but is not limited to, a local area network, a wide area network, or a combination of networks. In one embodiment of the present invention, network 460 includes the Internet. In some embodiments of the present invention, network 460 includes phone and cellular phone networks.

Database 470 can include any type of system for storing data in non-volatile storage. This includes, but is not limited to, systems based upon magnetic, optical, or magneto-optical storage devices, as well as storage devices based on flash memory and/or battery-backed up memory. Note that database 470 can be coupled: to a server (such as server 450), to a client, or directly to a network. In some embodiments of the present invention, database 470 is used to store information related to captured financial data. Alternatively, other entities in computing environment 400 may also store such data (e.g., servers 430-450).

Devices 480 can include any type of electronic device that can be coupled to a client, such as client 412. This includes, but is not limited to, cell phones, personal digital assistants (PDAs), smartphones, personal music players (such as MP3 players), gaming systems, digital cameras, portable storage media, or any other device that can be coupled to the client. Note that, in some embodiments of the present invention, devices 480 can be coupled directly to network 460 and can function in the same manner as clients 410-412.

Appliance 490 can include any type of appliance that can be coupled to network 460. This includes, but is not limited to, routers, switches, load balancers, network accelerators, and specialty processors. Appliance 490 may act as a gateway, a proxy, or a translator between server 440 and network 460.

Note that different embodiments of the present invention may use different system configurations, and are not limited to the system configuration illustrated in computing environment 400. In general, any device that supports capturing financial data using a camera may incorporate elements of the present invention.

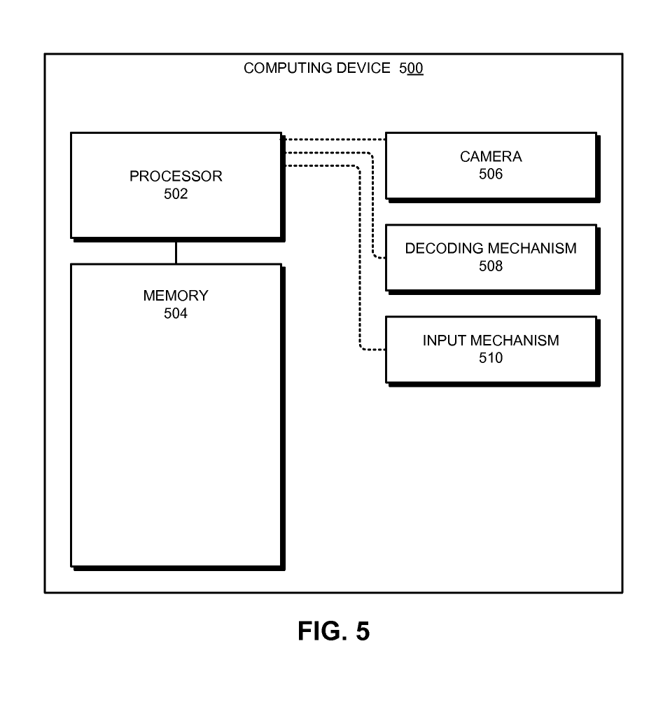

FIG. 5 illustrates a computing device 500 that includes a processor 502 and a memory 504. Computing device 500 also includes a camera 506, a decoding mechanism 508, and an input mechanism 510 associated with the browser application. Computing device 500 uses camera 506, decoding mechanism 508, and input mechanism 510 to capture financial data.

During operation, computing device 500 uses camera 506 to scan a barcode that is associated with a financial document. Decoding mechanism 508 decodes the barcode to generate a financial data set, and input mechanism 510 then inputs the financial data set into a financial application.

In some embodiments of the present invention, some or all aspects of camera 506, decoding mechanism 508, and/or input mechanism 510 can be implemented as dedicated hardware modules in computing device 500. These hardware modules can include, but are not limited to, processor chips, application-specific integrated circuit (ASIC) chips, field-programmable gate arrays (FPGAs), memory chips, and other programmable-logic devices now known or later developed.

Processor 502 can include one or more specialized circuits for performing the operations of the mechanisms. Alternatively, some or all of the operations of camera 506, decoding mechanism 508, and/or input mechanism 510 may be performed using general-purpose circuits in processor 502 that are configured using processor instructions. Thus, while FIG. 5 illustrates camera 506, decoding mechanism 508, and/or input mechanism 510 as being external to processor 502, in alternative embodiments some or all of these mechanisms can be internal to processor 502.

In these embodiments, when the external hardware modules are activated, the hardware modules perform the methods and processes included within the hardware modules. For example, in some embodiments of the present invention, the hardware module includes one or more dedicated circuits for performing the described operations. As another example, in some embodiments of the present invention, the hardware module is a general-purpose computational circuit (e.g., a microprocessor or an ASIC), and when the hardware module is activated, the hardware module executes program code (e.g., BIOS, firmware, etc.) that configures the general-purpose circuits to perform the operations described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for capturing financial data using a computing device, wherein the computing device includes a camera, the method comprising:
scanning a barcode using the camera, wherein the barcode is associated with a financial document;
generating a financial data set by decoding the barcode; and
inputting the financial data set into a financial application.

2. The computer-implemented method of claim 1,
wherein the financial document is a tax document; and
wherein inputting the financial data set into the financial application facilitates populating a tax return.

3. The computer-implemented method of claim 1,
wherein the barcode comprises a unique identifier; and
wherein generating the financial data set further comprises:
connecting to a remote server that stores financial data associated with the barcode; and
using the unique identifier to retrieve the financial data set from the remote server.

4. The computer-implemented method of claim 3, wherein using the unique identifier to retrieve the financial data set from the remote server further involves the user of the computing device providing authentication information to the remote server.

5. The computer-implemented method of claim 1,
wherein the financial application is hosted on a remote server; and
wherein inputting the financial data set to the financial application further involves connecting to the remote server and transferring the financial data to the remote server.

6. The computer-implemented method of claim 5,
wherein the financial data set comprises encrypted data that has been encrypted using the public key associated with the remote server; and
wherein the remote server uses a private key associated with the public key to decrypt the financial data set.

7. The computer-implemented method of claim 1,
wherein the barcode comprises a signed financial data set that has been signed by the entity that created the barcode; and
wherein signing the financial data set ensures data integrity and authenticity for the data set.

8. The computer-implemented method of claim 1, wherein the barcode is a multi-dimensional matrix barcode.

9. The computer-implemented method of claim 1, wherein the financial data set is compressed prior to being encoded into the barcode.

10. A non-transitory computer-readable storage medium storing instructions that when executed by a computing device that includes a camera cause the computing device to perform a method for capturing financial data, the method comprising:
scanning a barcode using the camera, wherein the barcode is associated with a financial document;
generating a financial data set by decoding the barcode; and
inputting the financial data set into a financial application.

11. The non-transitory computer-readable storage medium of claim 10,
wherein the financial document is a tax document; and
wherein inputting the financial data set into the financial application facilitates populating a tax return.

12. The non-transitory computer-readable storage medium of claim 10,
wherein the barcode comprises a unique identifier; and
wherein generating the financial data set further comprises:
connecting to a remote server that stores financial data associated with the barcode; and
using the unique identifier to retrieve the financial data set from the remote server.

13. The non-transitory computer-readable storage medium of claim 12, wherein using the unique identifier to retrieve the financial data set from the remote server further involves the user of the computing device providing authentication information to the remote server.

14. The non-transitory computer-readable storage medium of claim 10,
wherein the financial application is hosted on a remote server; and
wherein inputting the financial data set to the financial application further involves connecting to the remote server and transferring the financial data to the remote server.

15. The non-transitory computer-readable storage medium of claim 14,
wherein the financial data set comprises encrypted data that has been encrypted using the public key associated with the remote server; and
wherein the remote server uses a private key associated with the public key to decrypt the financial data set.

16. The non-transitory computer-readable storage medium of claim 10,
wherein the barcode comprises a signed financial data set that has been signed by the entity that created the barcode; and
wherein signing the financial data set ensures data integrity and authenticity for the data set.

17. The non-transitory computer-readable storage medium of claim 10, wherein the barcode is a multi-dimensional matrix barcode.

18. The non-transitory computer-readable storage medium of claim 10, wherein the financial data set is compressed prior to being encoded into the barcode.

19. A computing device configured to capture financial data, comprising:
a processor;
a memory;
a camera associated to scan a barcode that is associated with a financial document;
a decoding mechanism configured to generate a financial data set by decoding the barcode; and
an input mechanism configured to input the financial data set into a financial application.

20. The computing device of claim 19,
wherein the financial document is a tax document; and
wherein inputting the financial data set into the financial application facilitates populating a tax return.
